(19) United States
(12) Patent Application Publication
(10) Pub. No.: US 2015/0220709 A1
(43) Pub. Date: Aug. 6, 2015

(54) SECURITY-ENHANCED DEVICE BASED ON VIRTUALIZATION AND THE METHOD THEREOF

(71) Applicant: Electronics Telecommunications Research Institute, Daejeon (KR)

(72) Inventors: Young Woo JUNG, Daejeon (KR); Hag Young KIM, Daejeon (KR)

(21) Appl. No.: 14/599,278

(22) Filed: Jan. 16, 2015

(30) Foreign Application Priority Data
Feb. 6, 2014 (KR) 10-2014-0013486

(51) Int. Cl. G06F 21/30; H04L 29/06; G06F 9/455; G06F 21/45

(52) U.S. Cl. CPC G06F 21/30; G06F 21/45; H04L 63/0884; G06F 9/45533

(57) ABSTRACT

Disclosed is an electronic device for supporting enhanced security including: a processor; a memory; a virtual machine monitor; a first virtual machine in which a host operating system is operated; and a second virtual machine in which a security operating system is operated. Each operating system may access only system resources allocated through the virtual machine monitor.

### CROSS-REFERENCE TO RELATED APPLICATIONS

This application claims priority to and the benefit of Korean Patent Application No. 10-2014-0013486 filed in the Korean Intellectual Property Office on Feb. 6, 2014, the entire contents of which are incorporated herein by reference.

### TECHNICAL FIELD

The present invention relates to a technology for enhancing security of authentication credential information and/or an authentication module, which are used at the time of using services to be authenticated such as Internet banking and electronic commerce, using a virtualization technology.

### BACKGROUND ART

With the recent development of digital technologies, various electronic devices that can provide communication and personal information while movement, such as a mobile communication terminal, a personal digital assistant (PDA), an electronic notebook, a smart phone, and a tablet personal computer (PC), have been released. These electronic devices meet at a stage of mobile convergence which accommodates an area of other terminals as well as their own traditional area.

User terminals of the electronic devices include file systems in which authentication credential information required to use services requiring user authentication, such as Internet banking and electronic commerce, is stored. The user terminal may perform authentication through an authentication server using encrypted authentication information obtained by an authentication module based on the authentication credential information.

Under the environment, since operating systems or applications of the electronic devices may easily access the credential information, and the like, when the electronic devices suffer from hacking, malignant code, or the like, important information such as the authentication credential information may be easily leaked.

A server may integrally manage the authentication credential information and a client terminal may access the server through a network to use the encrypted authentication information. However, the method also requires an additional security process, such as key exchange, for security communication between the client and the server, and therefore when security of the client terminal is fragile, the authentication credential information managed by the server is not still safely managed.

### SUMMARY OF THE INVENTION

The present invention has been made in an effort to provide an apparatus and a method capable of radically preventing damage or leakage of important information such as authentication credential information which may be caused due to fragile security of operating systems of electronic devices, by safely serving authentication credential information and an authentication module in a virtualized security area using a virtualization technology which completely separates between the operating systems in the electronic devices such as a smart terminal

An exemplary embodiment of the present invention provides an electronic device for supporting enhanced security including: a processor; a memory; a virtual machine monitor; a first virtual machine in which a host operating system is operated; and a second virtual machine in which a security operating system is operated. Each operating system may access only system resources allocated through the virtual machine monitor.

The virtual machine monitor may support an event channel and a shared memory and the host operating system may communicate with the security operating system through the event channel.

When an authentication request is issued from an application operated on the host operating system, the host operating system may transfer an event for the authentication request to the security operating system through the event channel.

The second virtual machine may include at least one authentication module and at least one authentication credential and the authentication module may use the authentication credential to generate encrypted authentication information.

The encrypted authentication information may be transferred to the first virtual machine through the virtual machine monitor and may be used for authentication of the electronic device through an authentication server positioned outside the electronic device.

The host operating system may request the security information of the security operating system through the virtual machine monitor and the security operating system may transfer the security information generated in response to the request to the host operating system through the virtual machine monitor.

Another exemplary embodiment of the present invention provides an authentication performing method using a host operating system and a security operating system which are driven on different virtual machines including: transferring an authentication request from the host operating system to the security operating system through the virtual machine monitor; generating encrypted authentication information in response to the authentication request; and transferring the generated authentication information to the host operating system through the virtual machine monitor. The host operating system may use the authentication information for authentication by an authentication server.

According to the exemplary embodiments of the present invention, it is possible to provide the authentication service in the enhanced security environment to the user by making the authentication credential and the authentication module stored and operated by the existing host operating system be managed and operated in the security operating system area. It is possible to facilitate the conversion into the virtualization environment supporting the enhanced security by securely separating the security area without changing the existing interface.

### BRIEF DESCRIPTION OF THE DRAWINGS

FIG. 1 is a diagram illustrating a security system according to an exemplary embodiment of the present invention.

FIG. 2 is a diagram illustrating an authentication processing process according to an exemplary embodiment of the present invention.

FIG. 3 is a diagram illustrating a data transfer method between operating systems according to an exemplary embodiment of the present invention.

FIG. 4 is a diagram illustrating an authentication performing process according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, various exemplary embodiments of the present invention will be described in detail with reference to the accompanying drawings. Here, it is to be noted that like components in the accompanying drawings are denoted by like reference numerals if possible. A detailed description for well-known functions and configurations that may obscure the gist of the present invention will be omitted. That is, it is to be noted that only components required to help understand operations according to exemplary embodiments of the present invention will be described below and a description of other components will be omitted so as not to make the gist of the present invention obscure.

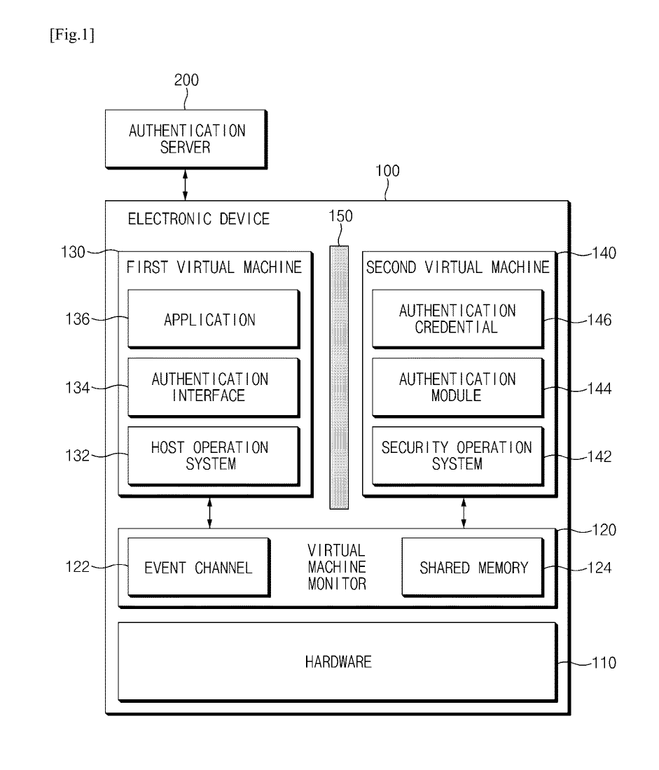

FIG. 1 is a diagram illustrating a security system according to an exemplary embodiment of the present invention. Referring to FIG. 1, a security system may include an electronic device 100 and an authentication server 200. The electronic device 100 may be smart terminals such as a smart phone or a tablet. However, the electronic device 100 may be a general desktop PC or laptop. In addition to this, the electronic device 100 may be various devices such as a PDA, a smart watch and smart glasses. The electronic device 100 may be generally any kind of device which is supported by a mobile virtualization technology. The virtualization technology is not limited only to the mobile virtualization technology but includes a virtualization technology which is applied to the desktop PC, the laptop, or the like to be able to implement exemplary embodiments of the present invention.

Generally, the virtualization technology means a technology which divides (or integrates) physical computer resources into logical computer resources to be able to effectively use system resources. The general virtualization technology uses a layer such as a virtual machine monitor (VMM) or a hypervisor to generate a virtual machine which makes a plurality of operating systems (OS) be operated like being operated on actual system hardware. The virtual machine monitor may have a control of a higher level than a supervisor or a kernel of the operating system, and prevent the virtual machines from directly connecting to the system hardware, and separate the virtual machines from each other.

Referring back to FIG. 1, the electronic device 100 may include hardware 110, a virtual machine monitor 120, a first virtual machine 130, and a second virtual machine 140.

The hardware 110 may include a processor and a memory. The hardware 110 may further include a user input/output device (I/O). In addition to this, the hardware 110 may further include additional modules, for example, various sensors, a display panel, and a communication module which are included in the electronic device 100.

The virtual machine monitor 120 supports virtualization to make at least two operating systems be operated in each virtual machine. The virtual machine monitor 120 supports an event channel 122 and a shared memory 124 for communication between the operating systems driven in different virtual machines.

In the first virtual machine 130, a host operating system 132 may be operated. A general application program 136 may be operated on the host operating system. The application program may be, for example, finance related applications such as mobile banking application of a smart phone. The application program 136 may be installed in plural on the host operating system 132 and driven. The host operating system 132 may support an authentication interface 134 according to the application program 136.

In the second virtual machine 140, a security operating system 142 may be operated. The second virtual machine 140 may include a plurality of authentication modules 144a to 144n and different authentication credentials 146a to 146n which support different encryption methods. In this configuration, the authentication credential is cryptographic personal information used in an information system and may include a public key used by one person, a pair of public key/private key for encryption algorithm, a public key certificate issued from a certification authority, trusted root certification authority (for example, KISA root certification authority) related information, a password, applied information, and the like. The second virtual machine 140 operated by the security operating system 142 is not connected to a network device to provide safe environment from the outside and may communicate with external devices, such as an authentication server 200, through the first virtual machine 130 operated by the host operating system 132 connected to the network device.

The virtual machine monitor 120 provides a complete separation state 150 between the first virtual machine 130 and the second virtual machine. The host operating system 132 and the security operating system 142 which are operated by each virtual machine may access only virtual system resources, for example, a virtual CPU, a virtual memory, or a virtual I/O device, which are allocated through the virtual machine monitor. In the environment, communication for information exchange between the host operating system 132 and the security operating system 142 may be performed through the event channel 122 and the shared memory 124.

The electronic device 100 supports the environment in which the host operating system area in which general applications are operated and the security operating system areas in which the authentication credential information are managed and the authentication modules are operated are simultaneously used. In particular, the security operating system 142 uses the authentication credential information used at the time of using services requiring security/authentication such as finance and settlement to transfer encrypted authentication information through the authentication module and the host operating system 132 (or application program 136) uses the received encrypted authentication information to be able to perform an authentication procedure through the external authentication server 200. By this configuration, the host operating system may request the required security information of the security operating system through the virtual machine monitor. When the request is received, the security operating system may generate security information in response to the request and transfer the generated security information to the host operating system through the virtual machine monitor. In this process, the required information or the generated information may be exchanged through the shared memory.

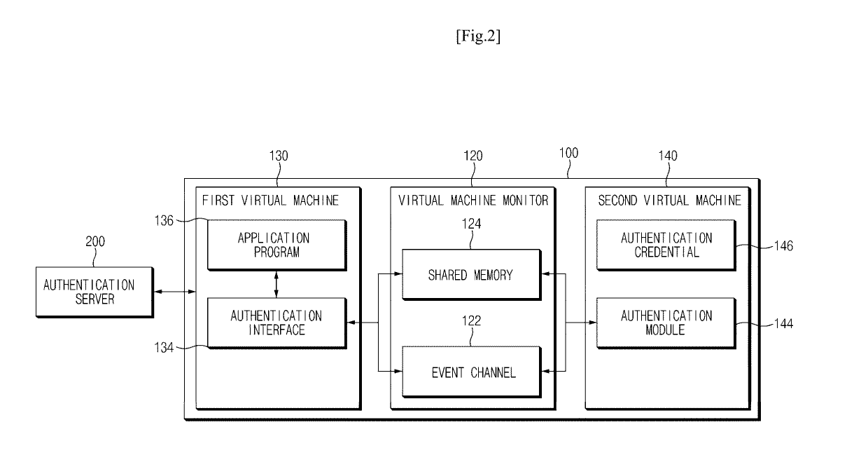

FIG. 2 is a diagram illustrating an authentication processing process according to an exemplary embodiment of the present invention.

For example, when the user accesses a bank account using bank applications of the electronic devices such as a smart phone, user (or terminal) authentication using the authentication information such as a public certificate may be requested. In this case, the application program 136 performs the authentication request through the authentication interface 134. The authentication interface 134 stores input information for authentication in a predefined memory area through the host operating system 132. The input information for authentication may also be input from the user (for example, password for a public certificate) and may be stored in the terminal in advance. When the input information for authentication is stored in the shared memory 124 supported by the virtual machine monitor 120, the host operating system 132 may transfer an event to the security operating system 142 driven on the second virtual machine 140 through the event channel 122 on the virtual machine monitor 120. In this configuration, the shared memory 124 means an area in which the host operating system 132 stores any information and which is supported by the virtual machine monitor to allow the security operating system 142 to access the information and does not mean a memory address which may be accessed by both of the host operating system 132 and the security operating system 142.

The authentication module 144 receiving the event through the security operating system 142 may use the authentication credential corresponding to the input information for authentication among the plurality of authentication credentials to generate the encrypted authentication information. The authentication module 144 records the generated encrypted authentication information in the shared memory area and transfers the event for authentication information to the host operating system through the event channel.

The authentication interface 134 (or application program 136) confirms the event transferred through the event channel and reads the encrypted authentication information from the defined memory area. The authentication interface 134 transfers the encrypted authentication information to the authentication server 200 through the network. The authentication server 200 returns an authenticated result based on the received authentication information to the authentication interface 134 and the authentication interface 134 transfers the returned authenticated result to the application program 136.

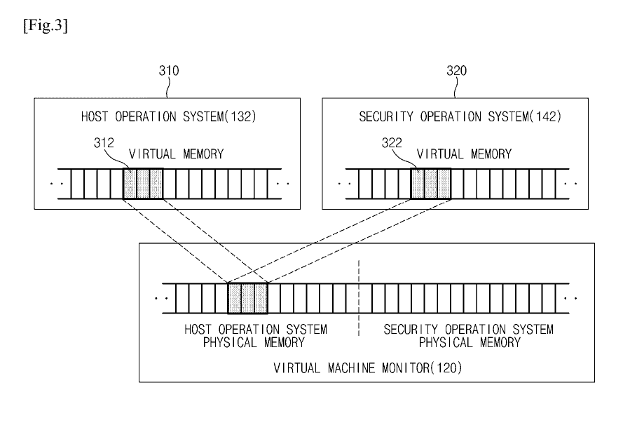

FIG. 3 is a diagram illustrating a data transfer method between operating systems according to an exemplary embodiment of the present invention.

Referring to FIG. 3, the host operating system 132 and the security operating system 142 may transfer data through the shared memory of the virtual machine monitor 120. The virtual machine monitor allocates each virtual memory for the host operating system and the security operating system. The virtual machine monitor 120 may separate a host operating system physical memory and a security operating system physical memory from each other in a physical memory. Therefore, the host operating system 132 may not access a physical memory area of the security operating system 142, and vice versa, the security operating system 142 may not access a physical memory area of the host operating system 132. The host operating system 132 allocates a first memory area 312 to be used as the shared memory and informs the virtual machine monitor of the allocation and the security operating system 142 may map and use the shared memory provided from the host operating system 132 to the memory address. When one operating system transfers the event for data transmission to another operating system, the virtual machine monitor 120 maps data of a specific memory area (for example, memory area 312) of the operating system (for example, the host operating system 132) transferring the event to a specific memory area (for example, the memory area 322) of the operating system (for example, the security operating system 142) receiving the event to be able to support the data exchange between different operating systems.

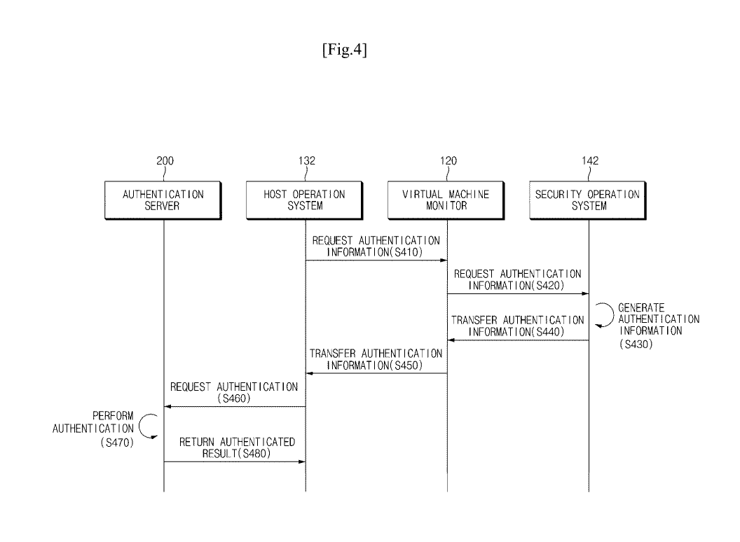

FIG. 4 is a diagram illustrating an authentication performing process according to an exemplary embodiment of the present invention.

Referring to FIG. 4, the authentication for the user or the electronic device 100 is performed among the authentication server 200 and the host operating system 132, the virtual machine monitor 120, and the security operating system 142 which configure the electronic device 100 In the description of FIG. 4, the host operating system 132 and the security operating system 142 may each be replaced by the second virtual machine 130 and the second virtual machine 140. In the description of FIG. 4, the overlapped description with the foregoing contents will be omitted.

In S410 and S420, the host operating system 132 requests the authentication information. The authentication information request is transferred to the security operating system 142 through the virtual machine monitor 120. In S410, the host operating system 132 may transfer the event through the event channel of the virtual machine monitor and record the information for authentication to the shared memory. In S420, the event through the event channel is transferred to the security operating system 142 and the security operating system 142 may acquire information for authentication on the shared memory.

In S430, the authentication module of the security operating system 142 figures out the corresponding authentication credential based on the acquired information to generate the encrypted authentication information. For example, the application of the host operating system 132 may receive a password, and the like of a public certificate through an input interface and the information is transferred to the security operating system 142. The security operating system 142 may accurately figure out the authentication credential through information on the application requesting the authentication information, the required certification information, and the like and acquire the authentication information through the received password, and the like. The authentication module may encrypt the authentication information to generate the encrypted authentication information. In S440 and S450, the security operating system 142 may transfer the encrypted authentication information to the host operating system. In S440, the security operating system 142 may store the generated authentication information in the shared memory and generate the event for generation of the authentication information. In S450, the event may be transferred to the host operating system 132 through the virtual machine monitor 120 and the host operating system 132 may acquire the authentication information generated from the shared memory.

In S460, the host operating system 132 requests the authentication of the authentication server 200. The authentication server 200 may perform the authentication in S470 and return the authenticated result to the electronic device 100 (that is, the host operating system 132) in S480.

All the embodiments and conditional examples disclosed in the present specification are described to help a person having ordinary skill in the art to which the present invention pertains to understand the principle and concept of the present invention and those skilled in the art may understand that the present invention may be implemented in a modified form within a range which does not deviate from the essential characteristics of the present invention. Therefore, the disclosed exemplary embodiments need to be considered in a descriptive aspect, not in a limited aspect. The scope of the present invention should be defined by the following claims rather than the above-mentioned description, and all technical spirits equivalent to the following claims should be interpreted as being included in the present invention.

What is claimed is:

1. An electronic device for supporting enhanced security, comprising:
a processor;
a memory;
a virtual machine monitor;
a first virtual machine in which a host operating system is operated; and
a second virtual machine in which a security operating system is operated,
wherein each operating system accesses only system resources allocated through the virtual machine monitor.

2. The electronic device of claim 1, wherein the virtual machine monitor supports an event channel and a shared memory, and
the host operating system communicates with the security operating system through the event channel.

3. The electronic device of claim 2, wherein when an authentication request is issued from an application operated on the host operating system, the host operating system transfers an event for the authentication request to the security operating system through the event channel.

4. The electronic device of claim 3, wherein the host operating system stores information associated with the authentication request in the shared memory.

5. The electronic device of claim 4, wherein the security operating system accesses information stored in the shared memory.

6. The electronic device of claim 5, wherein the host operating system allocates a portion of an area of the virtual memory of the host operating system to the shared memory and informs the virtual machine monitor of the allocation, and
the security operating system maps the shared memory to some of the area of the virtual memory of the security operating system.

7. The electronic device of claim 1, wherein the second virtual machine includes at least one authentication module and at least one authentication credential, and
the authentication module uses the authentication credential to generate encrypted authentication information.

8. The electronic device of claim 7, wherein the encrypted authentication information is transferred to the first virtual machine through the virtual machine monitor.

9. The electronic device of claim 8, wherein the encrypted authentication information is used for authentication of the electronic device through an authentication server positioned outside the electronic device.

10. The electronic device of claim 1, wherein the host operating system requests the security information of the security operating system through the virtual machine monitor, and
the security operating system transfers the security information generated in response to the request to the host operating system through the virtual machine monitor.

11. An authentication performing method using a host operating system and a security operating system which are driven on different virtual machines, comprising:
transferring an authentication request from the host operating system to the security operating system through the virtual machine monitor;
generating encrypted authentication information in response to the authentication request; and
transferring the generated authentication information to the host operating system through the virtual machine monitor,
wherein the host operating system uses the authentication information for authentication by an authentication server.

12. The method of claim 11, wherein the transferring of the authentication request includes:
storing information for authentication in a shared memory area; and
transferring an authentication request event to the security operating system through an event channel.

13. The method of claim 12, wherein the generating of the encrypted authentication information includes:
acquiring, by the authentication module of the security operating system, the information for authentication stored in the shared memory area; and
generating, by the authentication module, the encrypted authentication information using authentication credential corresponding to the information for authentication.

14. The method of claim 13, wherein the transferring of the authentication information includes:
storing the generated authentication information in a shared memory area; and
transferring an event for the authentication information to the host operating system through the event channel.

15. The method of claim 12, wherein the host operating system allocates a portion of an area of the virtual memory of the host operating system to the shared memory and informs the virtual machine monitor of the allocation, and
the security operating system maps the shared memory to some of the area of the virtual memory of the security operating system.
